(19) United States
(12) Patent Application Publication
(10) Pub. No.: US 2021/0187809 A1
(43) Pub. Date: Jun. 24, 2021

(54) INJECTION MOLDING MACHINE, CONTROL METHOD FOR INJECTION MOLDING MACHINE, AND RECORDING MEDIUM FOR STORING CONTROL PROGRAM OF INJECTION MOLDING MACHINE

(71) Applicant: SODICK CO., LTD., Kanagawa (JP)

(72) Inventors: Kenzo AKIYAMA, Kanagawa (JP); Shunta KUWAHARA, Kanagawa (JP)

(73) Assignee: SODICK CO., LTD., Kanagawa (JP)

(21) Appl. No.: 17/124,456

(22) Filed: Dec. 16, 2020

(30) Foreign Application Priority Data
Dec. 20, 2019 (JP) 2019-229913

(51) Int. Cl. B29C 45/76

(52) U.S. Cl. CPC B29C 45/766; B29C 2945/76939; B29C 2945/76916

(57) ABSTRACT

According to one aspect of the disclosure, an injection molding machine is provided. In the injection molding machine, a control device includes a molding condition storage device and a determination device. The molding condition storage device stores molding conditions. Here, the molding conditions include at least one transition molding condition from a state in which molding is stopped to the initiation of normal molding, and a normal molding condition during normal molding. The determination device determines whether or not to perform molding using the transition molding conditions based on at least one of a time after the molding is stopped and a temperature at a predetermined position after the molding is stopped.

### CROSS-REFERENCE TO RELATED APPLICATIONS

This application claims the priority benefit of Japanese Patent Application No. 2019-229913, filed on Dec. 20, 2019. The entirety of the above-mentioned patent application is hereby incorporated by reference herein and made a part of this specification.

### BACKGROUND

### Technical Field

The disclosure relates to an injection molding machine, a control method for an injection molding machine, and a recording medium for storing a control program of an injection molding machine.

### Related Art

In general, an injection molding machine repeats a process of injecting and filling a flowable molding material into a closed mold, solidifying the molding material in the mold, and then opening the mold to take out the molded article. The molded articles are articles molded at an initial stage of production immediately after the injection molding machine is started and articles molded during the subsequent stable period of production. The molded articles may differ in quality and yield even if they are molded under the same molding conditions. In addition, when the molded articles are continuously molded under the same molding conditions in the initial stage of production and the stable period of production as mentioned above, the injection molding machine may detect a fault and stop during molding. The fault detected at this time is, for example, release failure of the molded article, stringing of the molding material, or the like. Thus, in many cases, an operator stands beside the injection molding machine for a long period of time to prevent the injection molding machine from stopping for a long time.

The release failure is, for example, mold removal or remainder of sprue. Generally, for example, in the case of a two-plate mold, when the mold is opened, the molded article adheres to the plate on which a mold release part is arranged. The mold removal means that when the mold is opened, the molded article adheres to the plate on which the mold release part is not arranged. The remainder of sprue means that when the mold is opened, the sprue that forms a part of the molded article is torn off from the main body of the molded article and remains on the plate on which the mold release part is not arranged. The stringing of the molding material means that, for example, when the mold is opened in a state in which the front end of the sprue is not solidified, the front end of the sprue extends thinly like a thread and adheres to the mold.

Thus, in an injection molding machine, production is performed while changing molding conditions from the initial stage of production to the stable period of production, that is, transitioning the molding conditions (for example, see Patent literature 1).

### LITERATURE OF RELATED ART

### Patent Literature

Patent literature 1: Japanese Patent No. 2990406

### SUMMARY

However, when production is performed while transitioning the molding conditions, the transition of the molding conditions is started again from the initial molding condition every time the machine is stopped, thus leading to a reduction in production efficiency. In addition, the function of performing production while transitioning the molding conditions is manually operated by the operator and may not be used, and the determination is dependent on the operator.

The disclosure provides an injection molding machine that automatically determines whether to use the transition of molding conditions, a control method for an injection molding machine, and a recording medium for storing a control program of an injection molding machine. Additional objects and advantages of the disclosure will be set forth in the description that follows.

The disclosure provides an injection molding machine which is controlled by a control device according to molding conditions and injects and fills a flowable molding material into a mold to perform molding. The control device includes a molding condition storage device and a determination device. The molding condition storage device stores the molding conditions. Herein, the molding conditions include at least one of transition molding conditions from a state in which molding is stopped to the initiation of normal molding, and a normal molding condition during normal molding. The determination device determines whether or not to perform molding using the transition molding conditions based on at least one of a time after the molding is stopped and a temperature at a predetermined position after the molding is stopped.

The disclosure provides a control method for an injection molding machine which is controlled according to molding conditions and injects and fills a flowable molding material into a mold to perform molding. The control method includes a determination step of determining whether or not to perform molding using transition molding conditions based on at least one of a time after the molding is stopped and a temperature at a predetermined position after the molding is stopped. The transition molding conditions are the molding conditions from a state in which molding is stopped to the initiation of normal molding, which are different from the molding condition during normal molding.

The disclosure provides a recording medium for storing a control program of an injection molding machine which is controlled by a control device according to molding conditions and injects and fills a flowable molding material into a mold to perform molding. The control program makes a computer operate as the control device. The control device includes a molding condition storage device and a determination device. The molding condition storage device stores the molding conditions. Here, the molding conditions include at least one of transition molding conditions from a state in which molding is stopped to the initiation of normal molding, and a normal molding condition during normal molding. The determination device determines whether or not to perform molding using the transition molding conditions based on at least one of a time after the molding is stopped and a temperature at a predetermined position after the molding is stopped.

According to the disclosure, it is possible to automatically determine whether or not to use molding using the transition molding conditions by determining whether or not perform molding using the transition molding conditions based on at least one of the time after molding is stopped and the temperature at a predetermined position after molding is stopped.

### BRIEF DESCRIPTION OF THE DRAWINGS

FIG. 1 is a diagram for explaining an overview of an injection molding machine.

FIG. 2 is a diagram for explaining an overview of the injection molding machine.

FIG. 3 is a block diagram showing a functional configuration of an injection molding machine 10.

FIG. 4 is a diagram showing a position where temperature is detected by a temperature detector 34.

FIG. 5 is an activity diagram showing a processing flow from the stop to the start of the injection molding machine 10.

FIG. 6 is an activity diagram showing an example of an operation flow of the injection molding machine 10 during starting.

FIG. 7 is an activity diagram showing another example of an operation flow of the injection molding machine 10 during starting.

FIG. 8 is an activity diagram showing an operation flow of the injection molding machine 10 when molding conditions are switched.

### DESCRIPTION OF THE EMBODIMENTS

Hereinafter, an embodiment of the disclosure is described with reference to the drawings. The various features shown in the embodiment shown below can be combined with each other. In particular, a control device, a molding condition storage device, a determination device, a counting device, a clocking device, a mandatory defect determination device, a process monitoring device, and a temperature monitoring device described later may include, for example, a combination of hardware resources implemented by a generalized circuit and software information processing that can be specifically realized by these hardware resources. In addition, in the present embodiment, various information (program, each content, and the like) is handled, and such information is represented as a binary bit set composed of 0 or 1 depending on the level of a signal value, and communication and computation can be performed on the generalized circuit.

In addition, the generalized circuit is a circuit realized by at least appropriately combining a circuit, a circuitry, a processor, a memory, and the like. That is, the generalized circuit includes an application specific integrated circuit (ASIC), a programmable logic device (for example, a simple programmable logic device (SPLD), a complex programmable logic device (CPLD), a field programmable gate array (FPGA)), and the like.

1. Overview of Injection Molding Machine

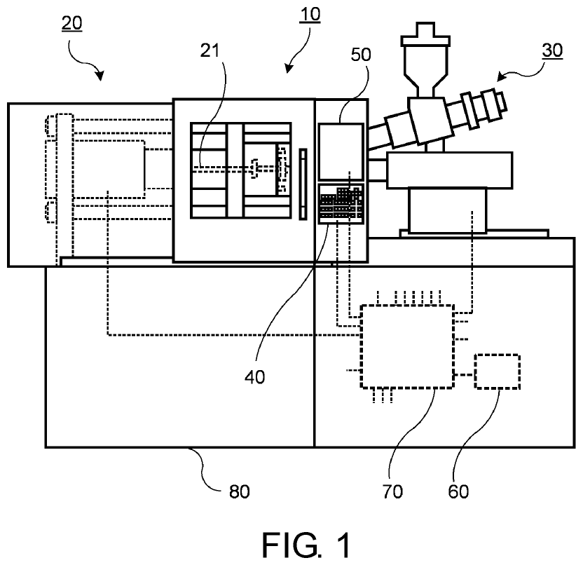

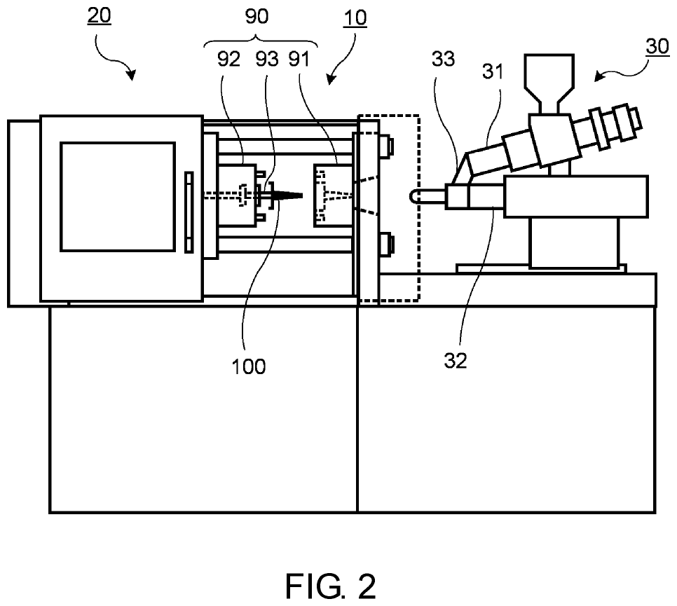

First, an injection molding machine is described. FIG. 1 and FIG. 2 are diagrams for explaining an overview of the injection molding machine. Molding materials molded by the injection molding machine include thermoplastic resins, thermosetting resins, light metal materials, and the like. Hereinafter, an injection molding machine 10 for molding a thermoplastic resin (hereinafter referred to as a resin material) is described as an example.

As shown in FIG. 1 and FIG. 2, the injection molding machine 10 includes a mold clamping device 20, an injection device 30, a control device 70 for controlling the mold clamping device 20 and the injection device 30, a memory 60, a display device 50, and an operation panel 40. The mold clamping device 20 and the injection device 30 are arranged on a base table 80. A mold 90 is attached to the mold clamping device 20. The mold 90 includes a fixed side mold 91, a movable side mold 92, and an ejector pin 93.

The mold clamping device is roughly classified into a direct pressure type and a toggle type, and the mold clamping device 20 shown in FIG. 1 and FIG. 2 is a direct pressure type. In addition, the injection device is roughly classified into a screw preplastication type and an in-line screw type, and the injection device 30 shown in FIG. 1 and FIG. 2 is a screw preplastication type. In the following, the injection molding machine 10 having a direct pressure type mold clamping device 20 and a screw preplastication type injection device 30 is described as an example.

The mold clamping device 20 includes a fixed platen, a movable platen, a support platen, a tie bar, a mold opening/closing drive device, a mold clamping drive device, and an ejection device.

The fixed platen and the support platen are fixed to both ends of the tie bar. The movable platen moves between the fixed platen and the support platen. The fixed side mold 91 is attached to the fixed platen. The movable side mold 92 is attached to the movable platen. The mold opening/closing drive device and the mold clamping drive device are attached to the support platen. The drive shaft of the mold opening/closing drive device and the drive shaft of the mold clamping drive device are attached to the movable platen. The mold opening/closing drive device and the mold clamping drive device drive in various ways, such as electric power, hydraulic power, or the like. Moreover, the mold opening/closing drive device and the mold clamping drive device may be composed of one drive device.

The mold opening/closing drive device includes, for example, a ball screw mechanism and a rotary motor, and moves the movable platen significantly when opening/closing the mold 90. The pressure applied to the movable platen can be detected from, for example, the value of the current flowing through the rotary motor. In addition, the pressure applied to the movable platen may also be detected by a pressure detector such as a load cell. The position and the moving speed of the movable platen can be detected by a position detector such as a rotary encoder for detecting the rotation speed of the rotary motor. In addition, for example, the position and the moving speed of the movable platen may also be detected by a position detector such as a linear encoder.

The mold clamping drive device is provided with, for example, a hydraulic actuator, and applies a large pressure to the movable platen when clamping the mold 90. The pressure for tightening the mold 90 can be detected from, for example, a pressure detector provided in the hydraulic actuator. In addition, the pressure for clamping the mold 90 may also be detected by a pressure detector such as a load cell.

The ejection device includes an ejector rod 21 and an ejector rod drive device. The ejection device is attached to the movable platen. The ejector rod 21 drives the ejector pin 93 of the movable side mold 92. The ejector rod drive device drives in various ways, such as electric power, hydraulic power, or the like.

The ejector rod drive device includes, for example, a ball screw mechanism and a rotary motor, and drives the ejector rod. The ejector pin 93 ejects the molded article 100 attached to the movable side mold 92 when the mold 90 is opened, and separates the molded article 100 from the movable side mold 92. The position and the moving speed of the ejector pin 93 can be detected by a position detector such as a rotary encoder for detecting the rotation speed of the rotary motor.

The injection device 30 includes a plasticizing part 31, an injection part 32, a connecting part 33 connecting the plasticizing part 31 and the injection part 32, and a backflow prevention device. The connecting part 33 includes a communication passage for communicating a plasticizing cylinder and an injection cylinder described later.

The plasticizing part 31 includes a plasticizing cylinder, a plasticizing screw, a screw rotation drive device, heaters H4, H5, H6, and a cooler CH. The screw rotation drive device drives in various ways, such as electric power, hydraulic power, or the like.

The plasticizing screw is housed in the plasticizing cylinder. A material supply port to which a resin material is supplied is formed at the rear portion of the plasticizing cylinder. The material supply port is fitted with, for example, a hopper.

The plasticizing screw is rotated inside the plasticizing cylinder. The screw rotation drive device includes, for example, a hydraulic motor and rotates the plasticizing screw. The rotation speed of the plasticizing screw is detected by a rotation detector such as a rotary encoder for detecting the rotation speed of the rotary motor.

The heaters H4, H5 and H6 are, for example, a plurality of band heaters wound around the outer periphery of the plasticizing cylinder, and heat the plasticizing cylinder by dividing it into a plurality of zones. The cooler CH is, for example, a cooling pipe formed in the rear zone of the plasticizing cylinder, and cools the rear zone of the plasticizing cylinder in which the material supply port is formed by making a cooling medium supplied from a cooling medium supply device flow through the cooling pipe. When, for example, a granular resin material is supplied from the hopper, the cooler CH prevents the surface of the resin material from melting due to heat and clogging the material supply port. The temperature of each zone of the plasticizing cylinder is detected by a temperature detector such as a thermocouple.

The resin material is supplied into the plasticizing cylinder. The resin material in the plasticizing cylinder is plasticized and melted by the plasticizing screw while being heated by the heaters H4, H5 and H6. The resin material in the plasticizing cylinder is melted while being moved toward the front end of the plasticizing screw by the rotating plasticizing screw, and supplied to the injection part through the communication passage when it becomes a flowable molten resin.

The injection part 32 includes an injection cylinder, an injection nozzle, a plunger, a plunger drive device, and heaters H0, H1, H2, H3 and HP.

The plunger is housed in the injection cylinder. The injection cylinder has an injection nozzle at the front end. An injection chamber is formed in the injection cylinder and communicates with the communication passage. The injection chamber accommodates the molten resin supplied from the plasticizing part 31 via the communication passage. The injection chamber communicates with the injection nozzle.

The plunger moves back and forth in the injection chamber to increase or decrease the volume of the injection chamber. The plunger drive device drives in various ways, such as electric power, hydraulic power, or the like. The plunger drive device includes, for example, a hydraulic actuator and moves the plunger in the front-rear direction. The pressure applied to the plunger can be detected by, for example, a pressure detector provided in the hydraulic actuator. In addition, the pressure applied to the plunger may also be detected by a pressure detector such as a load cell provided between the plunger and the injection drive device. The position of the plunger is detected by a position detector such as a linear encoder.

The heaters H1, H2, H3 and HP are, for example, a plurality of band heaters wound around the outer periphery of the injection cylinder, and heat the injection cylinder by dividing it into a plurality of zones. The temperature of each zone of the injection cylinder is detected by a temperature detector such as a thermocouple.

The heater H0 is, for example, a band heater wound around the outer periphery of the injection nozzle for heating the injection nozzle. The temperature of the injection nozzle is detected by a temperature detector such as a thermocouple.

The molten resin flows into the injection cylinder while pushing the plunger back until the plunger retracts to a predetermined place. The molten resin is metered according to the position where the plunger retracts. At this time, the plunger may be subjected to a back pressure which is smaller than the pressure of the molten resin and is in the forward direction of the plunger.

The connecting part 33 connects the plasticizing cylinder and the injection cylinder, and has a communication passage through which the molten resin supplied from the plasticizing cylinder to the injection cylinder flows. The connecting part 33 may include a heater HJ. The heater HJ is, for example, a band heater wound around the outer periphery of the connecting part 33 for heating the connecting part 33. The temperature of the connecting part 33 is detected by a temperature detector such as a thermocouple.

The backflow prevention device opens and closes the communication passage. The backflow prevention device includes, for example, a screw forward drive device, and advances the plasticizing screw to close the opening on the plasticizing part 31 side of the communication passage. The screw forward drive device drives in various ways, such as electric power, hydraulic power, or the like. The screw forward drive device includes, for example, a single-acting hydraulic actuator and hydraulically advances a non-rotating plasticizing screw. The advanced plasticizing screw retracts under the pressure of the molten resin fed out by the rotation of the plasticizing screw until the movement is restricted. In addition, the backflow prevention device may be configured to open and close the communication passage by driving various valves such as a check valve or a rotary valve with a valve drive device.

The mold 90 may include temperature adjusting devices D1, D2, D3, D4 and D5. The temperature adjusting devices D1, D2, D3, D4 and D5 may be configured to adjust each part of the mold 90 to a predetermined heating temperature by, for example, a plurality of cartridge heaters. The temperature adjusting devices D1, D2, D3, D4 and D5 are, for example, temperature adjusting pipes formed in the mold 90, and may be configured to adjust each part of the mold 90 to a predetermined temperature by making the cooling medium or the heating medium supplied from a temperature adjusting medium supply device flow through the temperature adjusting pipes. The temperature of each part of the mold 90 is detected by a temperature detector such as a thermocouple.

The operation panel 40 has operation keys for an operator to operate the injection molding machine 10. In addition, the operation panel 40 has input keys for the operator to input settings of the injection molding machine 10 including the molding conditions.

The display device 50 displays at least the settings. The display device 50 may have a transparent touch panel superimposed on the display screen and include input keys. The touch panel may be included in the operation panel 40.

The memory 60 records at least the settings. The memory 60 can also be configured to be included in the control device 70.

The control device 70 controls the mold clamping device 20 and the injection device 30 based on the settings including the molding conditions. The control device 70 controls, for example, the mold opening/closing drive device, the mold clamping drive device, the screw rotation drive device, the screw forward drive device, the plunger drive device, the ejector rod drive device, the heaters H0, H1, H2, H3, H4, H5, H6, HJ, HP, the cooler CH, the temperature adjusting device D1, the temperature adjusting device D2, the temperature adjusting device D3, the temperature adjusting device D4 and the temperature adjusting device D5 based on the settings. In addition, the control device 70 receives at least detection values output from the temperature detector, the rotation detector, the pressure detector and the position detector.

The control device 70 controls the injection molding machine 10 to repeat the molding cycle. In a mold closing step, the mold clamping device 20 closes the mold 90. In a mold clamping step, the mold clamping device 20 clamps the mold 90. In a filling step, the injection device 30 fills the mold 90 with the molten resin. In a dwelling step, the injection device 30 applies a dwell pressure to the molten resin in the mold 90. In a cooling step, the molten resin in the mold 90 is cooled and solidified into the shape of the molded article 100 after the dwell pressure is released. In a mold opening step, the mold clamping device 20 opens the mold 90. In an ejecting step, the ejection device ejects the molded article 100 adhered to the mold 90 and takes it out from the mold 90. In a metering step between the cooling step and the mold clamping step, the resin material is melted in the plasticizing part 31 and the molten resin is metered in the injection part 32. The molding cycle is, for example, from the start of the mold closing step to the start of the next mold closing step. In order to prevent the metered molten resin from leaking from the injection nozzle, the plunger may be retracted by the plunger drive device for a predetermined distance (suck back distance) at a predetermined speed (suck back speed) at the end of the metering step. Moreover the filling step and the dwelling step are collectively referred to as an injection step.

In the filling step, the filling speed is generally controlled according to the filling speed condition. In the filling step, the filling speed is indicated by the speed at which the plunger advances. In the filling step, the filling pressure is indicated by the pressure applied to the plunger. The filling step is a step of filling the molten resin into the mold 90. Moreover, in the filling step, the filling pressure may be preferentially controlled according to the filling pressure condition.

In the dwelling step, the dwell pressure is generally controlled according to the dwell pressure condition. In the dwelling step, the dwell pressure is indicated by the pressure applied to the plunger in the forward direction of the plunger. In the dwelling step, the dwell pressure is applied to the molten resin in the mold 90 through the molten resin remaining in the injection cylinder to replenish the amount of molten resin that is insufficient due to heat shrinkage of the molten resin in the mold 90.

The switching from the filling step to the dwelling step is called VP change. In the filling step, the timing of VP change is the time when the advancing plunger reaches a predetermined VP change position. In addition, in the filling step, another timing of VP change is the time when the pressure applied to the plunger gradually increases and reaches a predetermined VP change pressure after the advancing plunger exceeds a predetermined position.

In the metering step, the supply rate is generally controlled according to the supply rate condition when the flowable molding material is supplied into the injection chamber. For example, the supply rate condition when the molten resin is supplied to the injection chamber by the rotating plasticizing screw is the screw speed condition. For example, the supply rate is controlled by controlling the screw speed of the plasticizing screw according to the screw speed condition. The screw speed is indicated by the rotation speed per minute of the plasticizing screw. Furthermore, in the metering step, the back pressure may be controlled based on a back pressure condition. The back pressure is indicated by the pressure applied to the plunger in the forward direction of the plunger during metering. The supply rate condition may include the back pressure condition.

In the mold closing step, the mold closing speed is generally controlled according to the mold closing speed condition. The mold closing speed is indicated by the speed at which the movable platen moves toward the fixed platen. In the mold opening step, the mold opening speed is generally controlled according to the mold opening speed condition. The mold opening speed is indicated by the speed at which the movable platen moves toward the support platen.

The control device 70 detects a fault in the mold clamping device 20 and the injection device 30. The control device 70 performs control such as stopping the injection molding machine 10 according to the content of the fault. The control device 70 may control the memory 60 so as to record that, for example, the molded article 100 molded at that time is a defective article, depending on the content of the fault. Moreover, the fault of the mold clamping device 20 may include a fault detected by a mold monitoring device (not shown) for monitoring the mold 90.

The control device 70 receives various detection values output from the mold clamping device 20 and the injection device 30. The control device 70 monitors a plurality of monitoring values based on these detected values. Moreover, the detection values output from the mold clamping device 20 and the injection device 30 also include the detection values of the signals output only in an abnormal state or only in a normal state. In addition, the detection values output from the mold clamping device 20 and the injection device 30 also include the detection value of a signal indicating that the operator has pressed the emergency stop button.

Each detector is, for example, a temperature detector, a rotation detector, a pressure detector, and a position detector. The temperature detector detects the temperature of the plasticizing cylinder, the injection cylinder, the injection nozzle, the connecting part 33 and the mold 90. The rotation detector detects the rotation speed of the plasticizing screw. The pressure detector detects the pressure applied to the plunger and the movable platen. The position detector detects the position where the plunger and the movable platen have moved.

The monitoring values are, for example, cycle time, screw speed, metering time, back pressure, metering completion position, filling time, VP change pressure, VP change position, maximum filling pressure, minimum cushioning amount, final cushioning amount, and filling rate. Furthermore, the monitoring values may include, for example, the temperature of each part, the mold closing time, and the like.

The cycle time is the time of one molding cycle. The screw speed is, as mentioned above, the rotation speed per minute of the plasticizing screw. The metering time is the time from the start of metering to the end of metering. The back pressure is, as mentioned above, the pressure applied to the plunger in the forward direction of the plunger during metering. The metering completion position is the position of the plunger when the metering is completed.

The filling time is the time from the start of injection to the timing of the VP change. The VP change pressure is the filling pressure during VP change. The VP change position is the position of the plunger during VP change. The maximum filling pressure is the maximum pressure applied to the plunger from the start of the filling step to the end of the dwelling step. The minimum cushion is the position where the plunger is most advanced between the start of the filling step and the end of the dwelling step. The final cushion is the position of the plunger when the dwelling step is completed. The filling rate is calculated by dividing the distance from the metering completion position to the VP change position by the distance from the metering completion position to the minimum cushion. The temperature of each part is the temperature of the plasticizing cylinder, the injection cylinder, the injection nozzle, the connecting part 33, and the mold 90. The mold closing time is the time of the mold closing step.

The control device 70 determines that the injection molding machine 10, including the settings, is abnormal when the monitoring values exceed a preset maximum value, the monitoring values fall below a preset minimum value, or the monitoring values are out of a preset acceptable range. In addition, when the moving average value of the monitoring values is out of the preset acceptable range, the control device 70 may determine that a variation occurs in the molding process, that is, the injection molding machine 10, including the settings, is abnormal, and the molded article 100 formed at that time is a defective article. The acceptable range is, for example, a range from the maximum value to the minimum value.

Besides, some of the molding conditions are described. The cooling time is the time of the cooling step. The screw speed is, as mentioned above, the rotation speed per minute of the plasticizing screw. The back pressure is, as mentioned above, the pressure applied to the plunger in the forward direction of the plunger during metering.

The suck back amount is the above-mentioned suck back distance, and the suck back speed is, as mentioned above, a predetermined speed when the plunger is retracted by the plunger drive device after the metering step. The metering value indicates the amount of the molten resin metered according to the position where the plunger is retracted.

A filling speed V1 is a speed at which the plunger moves from the metering value to a filling position S1. A filling speed V2 is a speed at which the plunger moves between the filling position S1 and a filling position S2. A filling speed V3 is a speed at which the plunger moves between the filling position S2 and a filling position S3. A filling speed V4 is a speed at which the plunger moves between the filling position S3 and a filling position S4. A filling speed V5 is a speed at which the plunger moves between the filling position S4 and the VP change position.

A dwelling P1 is a pressure applied to the plunger during a dwelling time T1 after the VP change. A dwelling P2 is a pressure applied to the plunger during a dwelling time T2 after the dwelling P1 is applied. A dwelling P3 is a pressure applied to the plunger during a dwelling time T3 after the dwelling P2 is applied. A dwelling P4 is a pressure applied to the plunger during a dwelling time T4 after the dwelling P3 is applied.

An upper limit pressure is a maximum pressure that can be applied to the plunger in the filling step. In the filling step, no pressure above the upper limit pressure is applied to the plunger. A maximum filling time is the above-mentioned filling time, that is, the time from the start of injection to the timing of the VP change.

2. Configuration of Injection Molding Machine

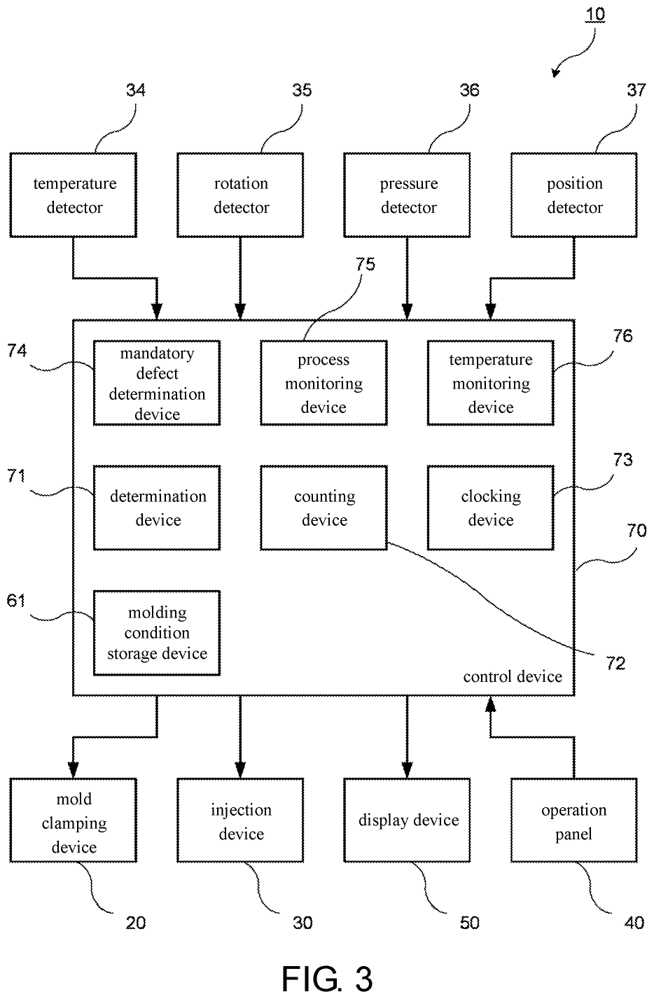

Next, a functional configuration of the injection molding machine 10 centering on the control device 70 is described. FIG. 3 is a block diagram showing the functional configuration of the injection molding machine 10.

The injection molding machine 10 is controlled according to the molding conditions, and injects and fills a flowable molding material into the mold 90 to perform molding. The injection molding machine 10 has the control device 70, and the control device 70 includes a molding condition storage device 61, a determination device 71, a counting device 72, a clocking device 73, a mandatory defect determination device 74, a process monitoring device 75 and a temperature monitoring device 76. Moreover, the molding condition storage device 61 is included in the memory 60, and the memory 60 can be included in the control device 70 as mentioned above, thus the control device 70 includes the molding condition storage device 61.

In addition, the control device 70 acquires detection results from each of a temperature detector 34, a rotation detector 35, a pressure detector 36, and a position detector 37, and acquires operation instructions from the operation panel 40. Then, the control device 70 controls each part of the mold clamping device 20 and the injection device 30, and displays information to be notified to the operator on the display device 50.

As mentioned above, the temperature detector 34 detects temperatures of the plasticizing cylinder, the injection cylinder, the injection nozzle, the connecting part 33, and the mold 90.

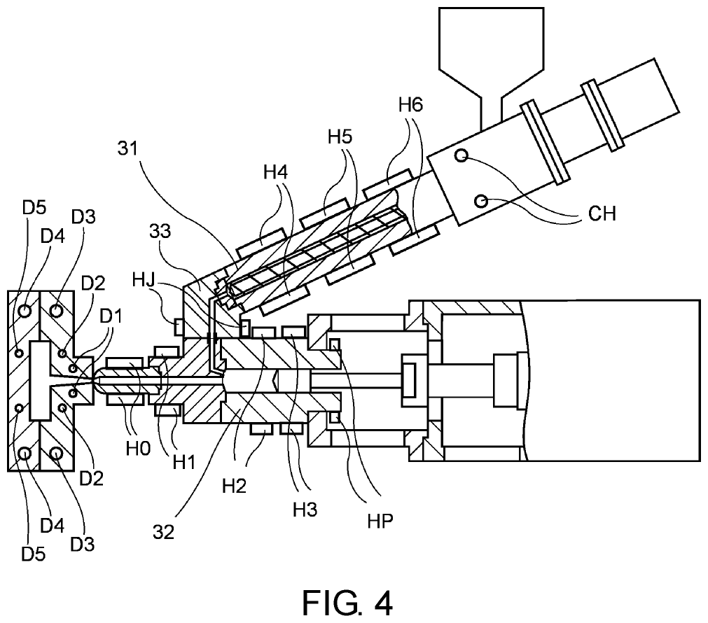

Here, a specific example of the position where the temperature detector 34 detects the temperature is described. FIG. 4 is a diagram showing a position where the temperature detector 34 detects the temperature. The temperature detector 34 detects the temperature of each part whose temperature is adjusted by, for example, the heater H0, the heater H1, the heater H2, the heater H3, the heater H4, the heater H5, the heater H6, the heater HJ, the heater HP, the cooler CH, the temperature adjusting device D1, the temperature adjusting device D2, the temperature adjusting device D3, the temperature adjusting device D4 and the temperature adjusting device D5 shown in FIG. 4. The cooler CH is a cooling pipe through which a cooling medium flows.

In addition, the rotation detector 35 detects, as mentioned above, the rotation speed of the plasticizing screw. The pressure detector 36 detects, as mentioned above, the pressure applied to the plunger and the movable platen. The position detector 37 detects, as mentioned above, the position where the plunger and the movable platen have moved.

The molding condition storage device 61 included in the control device 70 stores the molding conditions. The molding conditions include at least one transition molding condition from a state in which molding is stopped to the initiation of normal molding, and a normal molding condition during normal molding. The molding condition storage device 61 included in the control device 70 stores a plurality of input molding conditions. At least one of the plurality of molding conditions is a transition molding condition from a state in which molding is stopped to the initiation of normal molding. One of the plurality of molding conditions is a normal molding condition when normal molding is performed. The molding conditions including the transition molding conditions and the normal molding condition are necessary for controlling each part of the mold clamping device 20 and the injection device 30, and are, for example, the cooling time, the screw speed, the back pressure, the suck back amount, the suck back speed, the metering value, the filling speed V1, the filling speed V2, the filling speed V3, the filling speed V4, the filling speed V5, the dwelling P1, the dwelling P2, the dwelling P3, the dwelling P4, the upper limit pressure and the maximum filling time. In addition, the molding conditions include designation of whether or not to operate the mandatory defect determination device 74, designation of whether or not to operate the process monitoring device 75, and designation of whether or not to operate the temperature monitoring device 76. Moreover, among the molding conditions, the normal molding condition is designated not to operate the mandatory defect determination device 74.

In addition, among the molding conditions, the second and following transition molding conditions and the last normal molding condition may include at least one transition condition when molding is started by using the condition itself. One transition condition includes at least one condition item. The condition item of the transition condition is, but not limited to, for example, the number of molded articles (shot count) or elapsed time described later, and may be temperature or the like. For example, when the transition condition included in transition molding condition 2 is satisfied during molding using transition molding condition 1, transition molding condition 1 may be switched to transition molding condition 2 and the molding using transition molding condition 2 may be started. In addition, for example, when one of two different transition conditions included in transition molding condition 2 is satisfied during molding using transition molding condition 1, transition molding condition 1 may be switched to transition molding condition 2 and the molding using transition molding condition 2 may be started. Besides, for example, when the transition condition included in the normal molding condition is satisfied during molding using transition molding condition 1, transition molding condition 1 may be switched to the normal molding condition and the molding using the normal molding condition may be started. In addition, for example, when one of two different transition conditions included in the normal molding conditions is satisfied during molding using transition molding condition 1, transition molding condition 1 may be switched to the normal molding condition and the molding using the normal molding condition may be started. Furthermore, for example, during molding using transition molding condition 1, when the transition condition included in transition molding condition 2 is satisfied, transition molding condition 1 may be switched to transition molding condition 2 and the molding using transition molding condition 2 may be started; when the transition condition included in transition molding condition 3 is satisfied, transition molding condition 1 may be switched to transition molding condition 3 and the molding using transition molding condition 3 may be started; and when the transition condition included in the normal molding condition is satisfied, transition molding condition 1 may be switched to the normal molding condition and the molding using the normal molding condition may be started.

In addition, among the molding conditions, the transition molding conditions may include at least one transition condition for switching to the next transition molding condition or the next normal molding condition. One transition condition includes at least one condition item. The condition item of the transition condition is, but not limited to, for example, the number of molded articles (shot count) or elapsed time described later, and may be temperature or the like. For example, one transition condition may be included in transition molding condition 1 and used for switching to transition molding condition 2. In addition, for example, two different transition conditions may be included in transition molding condition 1 and both be used for switching to transition molding condition 2. Besides, for example, two different transition conditions may be included in transition molding condition 1, one used for switching to transition molding condition 2 and the other used for switching to transition molding condition 3. In addition, for example, one transition condition may be included in transition molding condition 1 and used for switching to the normal molding condition. Besides, for example, two different transition conditions may be included in transition molding condition 1 and both be used for switching to the normal molding condition. Also, for example, two different transition conditions may be included in transition molding condition 1, one used for switching to transition molding condition 2 and the other used for switching to the normal molding condition. Furthermore, for example, three different transition conditions may be included in transition molding condition 1, the first transition condition used for switching to transition molding condition 2, the second transition condition used for switching to transition molding condition 3, and the third transition condition used for switching to the normal molding condition.

The determination device 71 can determine whether or not to perform the molding using the transition molding conditions based on at least one of the stop time indicating the time after the molding is stopped and the temperature at a predetermined position after the molding is stopped. In addition, the determination device 71 switches the molding conditions based on the transition conditions when molding is performed based on the transition molding conditions.

The counting device 72 counts the number of the molded articles. The number of the molded articles counted by the counting device 72 includes both non-defective articles and defective articles. In addition, the number of the molded articles counted by the counting device 72 may be only non-defective articles. Besides, the number of the molded articles counted by the counting device 72 may be only defective articles. The number of the molded articles counted by the counting device 72 may be counted from the time when molding is started based on the initial transition molding condition. In addition, the number of the molded articles counted by the counting device 72 may be counted from the time when the transition molding condition is switched and molding is started based on another transition molding condition.

The clocking device 73 counts the time. The clocking device 73 may always counts time like a clock, or may counts time only when necessary like a stopwatch or the like. The clocked result obtained by the clocking device 73 is used to calculate the passage of time and the speed. The clocking device 73 counts the elapsed time. The elapsed time may be counted from the time when molding is started based on the initial transition molding condition. In addition, the elapsed time may be counted from the time when the transition molding condition is switched and molding is started based on another transition molding condition.

The mandatory defect determination device 74 forcibly determines a molded article obtained by molding based on the transition molding conditions as a defective article. Because the mandatory defect determination device 74 determines all the molded articles as defective articles during operation, the detection results of the temperature detector 34, the rotation detector 35, the pressure detector 36, and the position detector 37 are not required.

The process monitoring device 75 determines the quality of the molded article by monitoring at least one of the filling step in which the filling speed is controlled according to the filling speed condition, the dwelling step in which the dwell pressure is controlled according to the dwell pressure condition, and the metering step in which the supply rate is controlled according to the supply rate condition. The process monitoring performed by the process monitoring device 75 determines the quality of the molded article, and performs a predetermined operation, for example, an informing operation such as sounding an alarm or stopping the machine when the determination of defective article continues a predetermined number of times. The targets of the process monitoring may include, for example, at least one of the above-mentioned monitoring values, that is, the cycle time, the screw speed, the metering time, the back pressure, the metering completion position, the filling time, the VP change pressure, the VP change position, the maximum filling pressure, the minimum cushioning amount, the final cushioning amount, and the filling rate. In addition, the target of the process monitoring may include the mold closing time. Furthermore, the target of process monitoring may include the temperature of each part. That is, the temperature may also be included in the determination item for determining the quality of the molded article. Moreover, even if the process monitoring device 75 is not operated, temperature monitoring described later is performed when the operation of the temperature monitoring device 76 is designated. In this case, the determination of the quality of the molded article according to the temperature is not performed.

The temperature monitoring device 76 monitors the temperature at a predetermined position and determines whether or not the temperature is within a predetermined acceptable range. The temperature monitoring device 76, for example, monitors the temperature at a predetermined position in at least one of the injection molding machine 10, the mold 90, and their peripheral devices, and determines whether or not the temperature is within a predetermined acceptable range. In the temperature monitoring by the temperature monitoring device 76, for example, the temperature detector 34 described above monitors the temperature of each part whose temperature is adjusted by the heater H0, the heater H1, the heater H2, the heater H3, the heater H4, the heater H5, the heater H6, the heater HJ, the heater HP, the cooler CH, the temperature adjusting device D1, the temperature adjusting device D2, the temperature adjusting device D3, the temperature adjusting device D4, and the temperature adjusting device D5, and performs a predetermined operation, for example, an informing operation such as sounding an alarm or stopping the machine when the temperature of any of these parts exceeds the acceptable range.

3. Operation of Injection Molding Machine

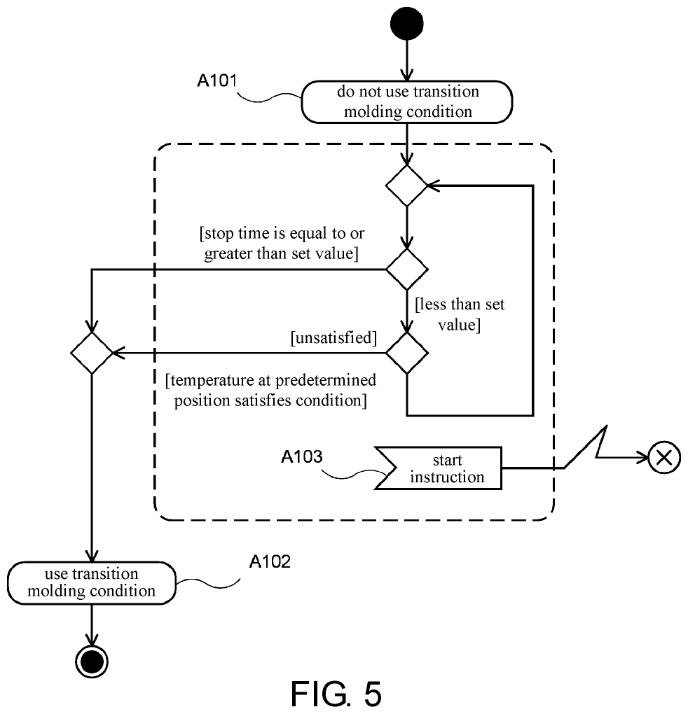

Next, the operation of the injection molding machine 10 is described. FIG. 5 is an activity diagram showing a processing flow from the stop to the start of the injection molding machine 10.

When the injection molding machine 10 stops the operation of molding the molded article, the determination device 71 determines that the transition molding conditions are not used, that is, the normal molding condition is applied at the next startup (A101). Then, when the stop time of the injection molding machine 10 exceeds the set value or the temperature at the predetermined position does not meet the conditions, the determination device 71 determines that the transition molding conditions are applied at the next startup (A102).

Therefore, if the temperature at the predetermined position meets the conditions before the stop time of the injection molding machine 10 exceeds the set value and the start of the injection molding machine 10 is instructed (A103), the injection molding machine 10 is started in a state in which it is determined that the transition molding conditions are not used. In addition, if the stop time of the injection molding machine 10 exceeds the set value or the temperature at the predetermined position does not meet the conditions, the injection molding machine 10 is started in a state in which it is determined to use the transition molding conditions.

In this way, the control method for the injection molding machine 10 which is controlled according to the molding conditions and injects and fills a flowable molding material into the mold 90 to perform molding includes a determination step of determining whether or not to perform the molding using the transition molding conditions based on at least one of the time after the molding is stopped and the temperature at the predetermined position after the molding is stopped.

The transition molding conditions are the molding conditions from a state in which molding is stopped to the initiation of normal molding, which are different from the molding condition during normal molding.

Subsequently, the operation of the injection molding machine 10 from the start of the injection molding machine 10 until the normal molding to which the normal molding conditions are applied is described.

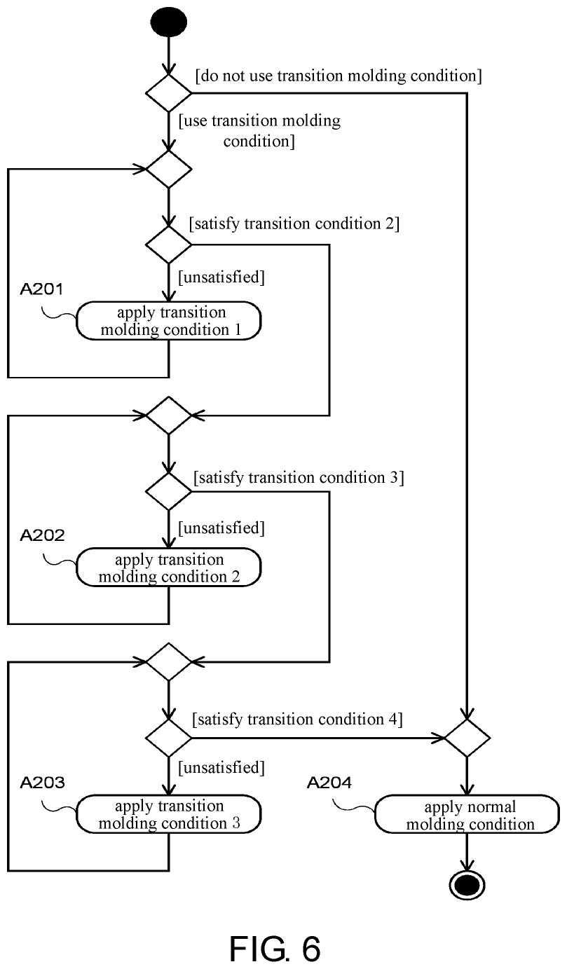

FIG. 6 is an activity diagram showing an example of an operation flow of the injection molding machine 10 during starting. Moreover, transition molding condition 1 not including a transition condition, transition molding condition 2 including transition condition 2, transition molding condition 3 including transition condition 3, and the normal molding condition including transition condition 4 are used here as the molding conditions.

When the determination device 71 determines that the transition molding condition is to be used when the injection molding machine 10 is started, the injection molding machine 10 applies transition molding condition 1 to perform molding until transition condition 2 is satisfied (A201).

Then, when transition condition 2 is satisfied, the injection molding machine 10 applies transition molding condition 2 to perform molding until transition condition 3 is satisfied (A202).

Furthermore, when transition condition 3 is satisfied, the injection molding machine 10 applies transition molding condition 3 to perform molding until transition condition 4 is satisfied (A203).

Subsequently, when transition condition 4 is satisfied, the injection molding machine 10 applies the normal molding condition to perform molding (A204).

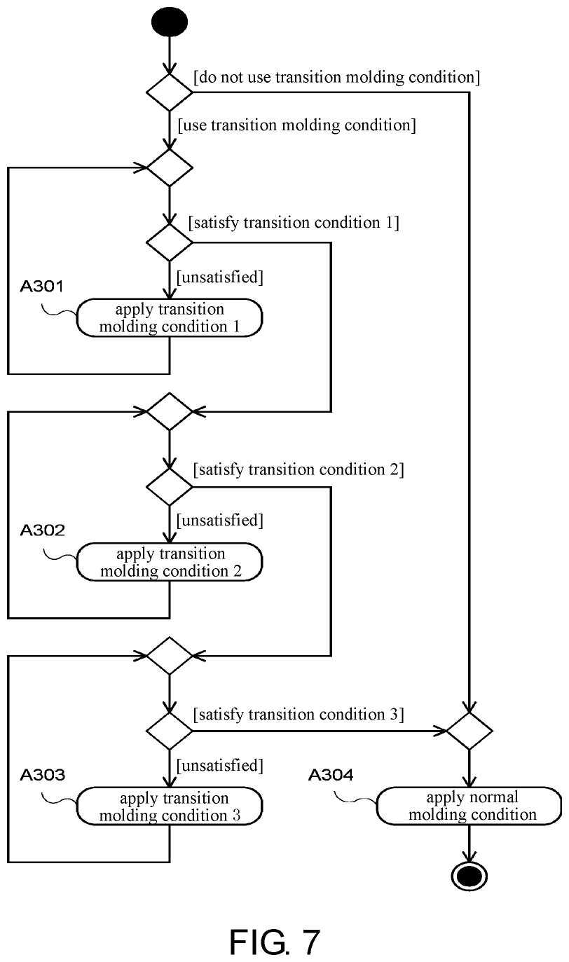

In addition, FIG. 7 is an activity diagram showing another example of an operation flow of the injection molding machine 10 during starting. Moreover, transition molding condition 1 including transition condition 1, transition molding condition 2 including transition condition 2, transition molding condition 3 including transition condition 3, and the normal molding condition not including transition conditions are used here as molding conditions.

When the determination device 71 determines that the transition molding condition is to be used when the injection molding machine 10 is started, the injection molding machine 10 applies transition molding condition 1 to perform molding until transition condition 1 is satisfied (A301).

Then, when transition condition 1 is satisfied, the injection molding machine 10 applies transition molding condition 2 to perform molding until transition condition 2 is satisfied (A302).

Furthermore, when transition condition 2 is satisfied, the injection molding machine 10 applies transition molding condition 3 to perform molding until transition condition 3 is satisfied (A303).

Subsequently, when transition condition 2 is satisfied, the injection molding machine 10 applies the normal molding condition to perform molding (A304).

On the other hand, when the determination device 71 determines that the transition molding condition is not used when the injection molding machine 10 is started, the injection molding machine 10 applies the normal molding condition to perform molding immediately after the start (A304).

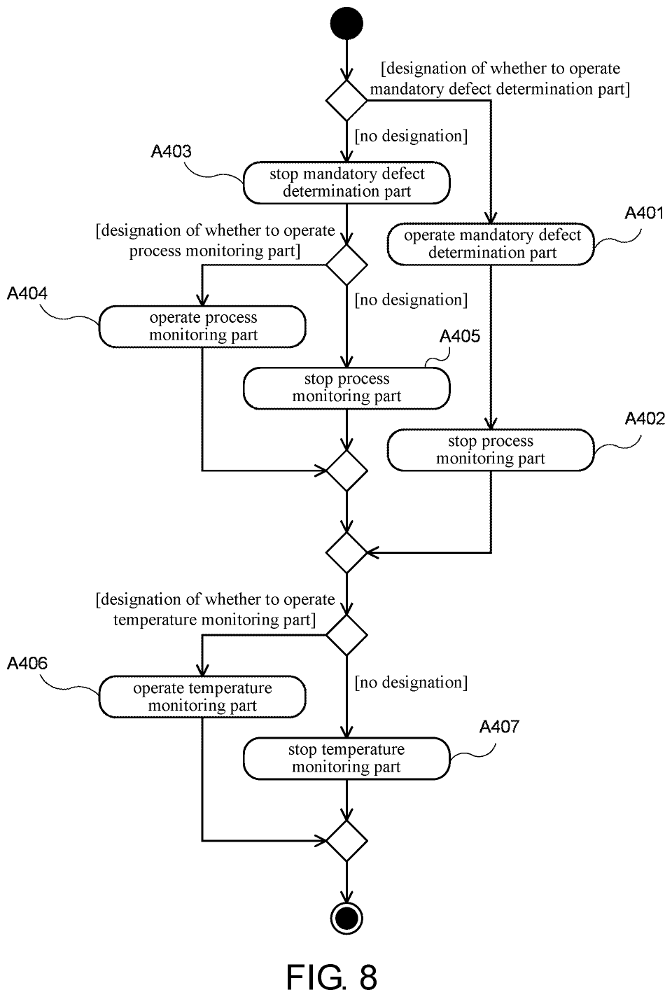

Next, the presence or absence of operation of the mandatory defect determination device 74, the process monitoring device 75, and the temperature monitoring device 76 based on the molding conditions is described. FIG. 8 is an activity diagram showing an operation flow of the injection molding machine 10 when the molding conditions are switched.

If the operation of the mandatory defect determination device 74 is designated when the injection molding machine 10 is started or when the molding conditions are switched, the control device 70 operates the mandatory defect determination device 74 (A401) and stops the operation of the process monitoring device 75 (A402). The reason is that the operation of the process monitoring device 75 is unnecessary because the mandatory defect determination device 74 determines all the molded articles as defective articles.

On the other hand, if the operation of the mandatory defect determination device 74 is not designated when the injection molding machine 10 is started or when the molding conditions are switched, the control device 70 stops the mandatory defect determination device 74 (A403). Then, if the operation of the process monitoring device 75 is designated, the process monitoring device 75 is operated (A404), and if the operation of the process monitoring device 75 is not designated, the process monitoring device 75 is stopped (A405).

Then, the control device 70 operates the temperature monitoring device 76 if the operation of the temperature monitoring device 76 is designated (A406), stops the temperature monitoring device 76 if the operation of the temperature monitoring device 76 is not designated (A407), and then causes the injection molding machine 10 to perform molding.

4. Others

The control device 70 described above can operate a computer by a control program. In this case, a control program of the injection molding machine 10 which is controlled by the control device 70 according to the molding conditions and injects and fills a flowable molding material into the mold 90 to perform molding makes the computer operate as the control device 70 of the injection molding machine 10. The control device 70 includes the molding condition storage device 61 and the determination device 71. The molding condition storage device 61 stores the molding conditions. Here, the molding conditions include at least one transition molding condition from the state in which molding is stopped to the initiation of normal molding, and the normal molding condition for performing the normal molding. The determination device 71 determines whether or not to perform the molding using the transition molding conditions based on at least one of a time after the molding is stopped and a temperature at a predetermined position after the molding is stopped.

In addition, a computer-readable non-temporary recording medium for storing the control program of the injection molding machine 10 may be provided.

The embodiment was chosen in order to explain the principles of the invention and its practical application. Many modifications and variations are possible in light of the above teachings. It is intended that the scope of the invention be defined by the claims.

What is claimed is:

1. An injection molding machine which is controlled by a control device according to molding conditions and injects and fills a flowable molding material into a mold to perform molding,
wherein the control device comprises a molding condition storage device and a determination device,
the molding condition storage device stores the molding conditions, wherein the molding conditions comprise at least one of transition molding conditions from a state in which molding is stopped to an initiation of normal molding, and a normal molding condition during normal molding, and
the determination device determines whether or not to perform molding using the transition molding conditions based on at least one of a time after the molding is stopped and a temperature at a predetermined position after the molding is stopped.

2. The injection molding machine according to claim 1,
wherein a second and following transition molding conditions and a last normal molding condition comprise at least one of transition conditions when molding is started by using the second and following transition molding conditions and the last normal molding condition, and
when molding is performed based on the molding conditions, the determination device switches the molding conditions based on the transition conditions.

3. The injection molding machine according to claim 2,
wherein the transition conditions are a number of molded articles or elapsed time.

4. The injection molding machine according to claim 1,
wherein the transition molding conditions comprise at least one of transition conditions for switching to the next transition molding condition or the next normal molding condition, and
when molding is performed based on the molding conditions, the determination device switches the molding conditions based on the transition conditions.

5. The injection molding machine according to claim 4,
wherein the transition conditions are a number of molded articles or elapsed time.

6. The injection molding machine according to claim 1,
wherein the control device comprises a mandatory defect determination device,
the mandatory defect determination device determines that a molded article obtained by molding based on the transition molding conditions is a defective article, and
the molding conditions comprise a designation of whether or not to operate the mandatory defect determination device.

7. The injection molding machine according to claim 1,
wherein the control device comprises a process monitoring device,
the process monitoring device determines a quality of a molded article by monitoring at least one filling step in which filling speed is controlled according to a filling speed condition, a dwelling step in which a dwell pressure is controlled according to a dwell pressure condition, and a metering step in which supply rate is controlled according to a supply rate condition, and
the molding conditions comprise a designation of whether or not to operate the process monitoring device.

8. The injection molding machine according to claim 1,
wherein the control device comprises a temperature monitoring device,
the temperature monitoring device monitors the temperature at the predetermined position and determines whether or not the temperature is within a predetermined acceptable range, and
the molding conditions comprise a designation of whether or not to operate the temperature monitoring device.

9. A control method for an injection molding machine which is controlled according to molding conditions and injects and fills a flowable molding material into a mold to perform molding, the control method comprising:
a determination step of determining whether or not to perform molding using transition molding conditions based on at least one of a time after the molding is stopped and a temperature at a predetermined position after the molding is stopped,
wherein the transition molding conditions are the molding conditions from a state in which molding is stopped to an initiation of normal molding, which are different from the molding condition during normal molding.

10. A recording medium for storing a control program of an injection molding machine which is controlled by a control device according to molding conditions and injects and fills a flowable molding material into a mold to perform molding,
wherein the control program makes a computer operate as the control device,
the control device comprises a molding condition storage device and a determination device,
the molding condition storage device stores the molding conditions, wherein the molding conditions comprise at least one of transition molding conditions from a state in which molding is stopped to an initiation of normal molding, and a normal molding condition during normal molding, and
the determination device determines whether or not to perform molding using the transition molding conditions based on at least one of a time after the molding is stopped and a temperature at a predetermined position after the molding is stopped.
